(19) United States
(12) Patent Application Publication
(10) Pub. No.: US 2016/0315999 A1
(43) Pub. Date: Oct. 27, 2016

(54) DEVICE AND METHOD FOR ASSOCIATING APPLICATIONS

(71) Applicant: HISENSE ELECTRIC CO., LTD., Qingdao (CN)

(72) Inventor: Xuebin Sun, Qingdao (CN)

(21) Appl. No.: 14/982,144

(22) Filed: Dec. 29, 2015

(30) Foreign Application Priority Data
Apr. 24, 2015 (CN) 201510203049.1

(51) Int. Cl. H04L 29/08; G06F 15/167

(52) U.S. Cl. CPC H04L 67/10; G06F 15/167

(57) ABSTRACT

A device for associating applications includes a memory storing codes, and a processor executing the codes to perform: receiving an application start instruction including an identifier of an application to be started; retrieving at least an identifier of one associated application corresponding to the identifier of the application to be started, from pre-stored association relationships which are correspondence relationships between identifiers of applications to be started and identifiers of associated applications; and allocating memory resources to all or a part of the associated applications corresponding to the retrieved identifiers of the associated applications.

### CROSS-REFERENCE TO RELATED APPLICATION

This application claims the benefit and priority of Chinese Patent Application No. 201510203049.1 filed Apr. 24, 2015. The entire disclosure of the above application is incorporated herein by reference.

### FIELD

The present disclosure relates to the field of computer applications and particularly to a device and method for associating applications.

### BACKGROUND

This section provides background information related to the present disclosure which is not necessarily prior art.

With the rapid development of sciences and technologies, numerous electronic products have been provided with smart touch screens, e.g., smart handsets, iPads, etc. The smart electronic products have standalone operating systems, so their uses can install as desired various applications available from third-party service providers to thereby extend the functions of the smart electronic products due to these applications. The smart electronic products can be widely applied due to their openness, strong operability, and other characteristics.

The respective applications installed in the electronic products will not be applications independent of each other any longer, that is, one of the applications may need to operate in cooperation with another application, for example, an application 1 is capable of instant communication, and when there is a network address link in an instant message, if the network address link is selected by the user, then the electronic product may start a locally installed browser application and further present a page corresponding to the network address link to the user; and in another example, an application 2 is capable of exhibiting commodity information and selling commodities but incapable of payment, and if the user needs to purchase any one of the commodities in an interface available from the application 2, then an application capable of payment may be started.

### SUMMARY

This section provides a general summary of the disclosure, and is not a comprehensive disclosure of its full scope or all of its features.

Particular technical solutions according to embodiments of the disclosure are as follows:

A device for associating applications includes a memory storing codes, and a processor performing the codes to perform:

receiving an application start instruction including an identifier of an application to be started;

retrieving the at least an identifier of one associated application corresponding to the identifier of the application to be started, from pre-stored association relationships which are correspondence relationships between identifiers of applications to be started and identifiers of associated applications; and

allocating memory resources to all or a part of the associated applications corresponding to the retrieved identifiers of the associated applications.

A method for associating applications includes:

receiving an application start instruction including an identifier of an application to be started;

retrieving at least an identifier of one associated application corresponding to the identifier of the application to be started, from pre-stored association relationships which are correspondence relationships between identifiers of applications to be started and identifiers of associated applications; and

allocating memory resources to all or a part of the associated applications corresponding to the retrieved identifiers of the associated applications.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a flow chart of starting an application according to an embodiment of the disclosure;

FIG. 2 illustrates a first schematic diagram of an association relationship table according to an embodiment of the disclosure;

FIG. 3 illustrates a second schematic diagram of an association relationship table according to an embodiment of the disclosure;

FIG. 4 illustrates a schematic structural diagram of a device for starting an application according to an embodiment of the disclosure; and

FIG. 5 illustrates a schematic structural diagram of a terminal according to an embodiment of the disclosure.

### DETAILED DESCRIPTION

Example embodiments will now be described more fully with reference to the accompanying drawings.

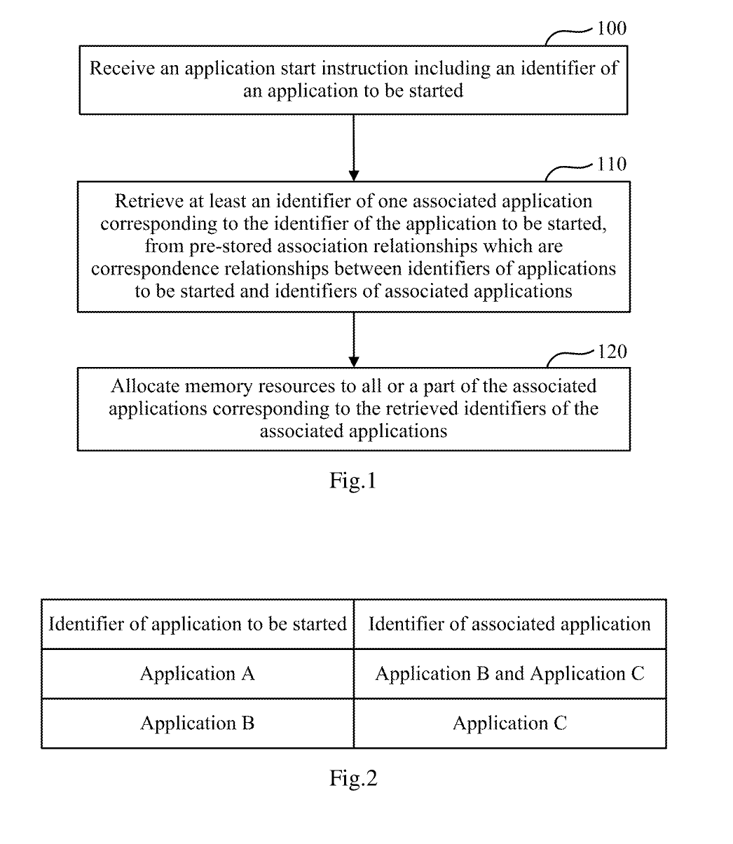

Referring to FIG. 1, a method for executing an application according to an embodiment of the disclosure includes:

The operation 100 is to receive an application start instruction including an identifier of an application to be started.

In an embodiment of the disclosure, there are a plurality of applications installed in an electronic product, and the electronic product detects in real time whether an application start instruction is issued by a user, where the application start instruction can be generated in a number of forms, for example, if the electronic product detects that any one of the application is selected by the user, than the electronic product may determine the selection operation as the application start instruction issued by the user; or if the user inputs the identifier of the application to be started, in a user interaction interface of the electronic product, and decides to execute the application corresponding to the identifier of the application to be started, then the electronic product may determine the operation of starting the application corresponding to the identifier of the application to be started, as the application start instruction. Moreover the application start instruction can alternatively be issued by another electronic product, or another application in the electronic product.

The operation 110 is to retrieve at least an identifier of one associated application corresponding to the identifier of the application to be started, from pre-stored association relationships which are correspondence relationships between identifiers of applications to be started and identifiers of associated applications.

In an embodiment of the disclosure, the electronic product pre-creates locally the association relationships including the correspondence between the identifiers of the applications to be started and the identifiers of the associated applications; the electronic product searches the locally stored association relationships for the identifier of the application to be started; and the electronic product retrieves the identifier of the associated application corresponding to the identifier of the application to be started.

Optionally the association relationships are created in the electronic product by performing for any one of the applications in the electronic product the operations of: parsing the any one application for all the functional scripts in the any one application, obtaining an application corresponding to each of the function scripts respectively, and if there is locally an application corresponding to the function script, then determining the application corresponding to the function script as an associated application corresponding to the any one application, and storing locally a correspondence relationship between the identifier of the any one application and the identifier of the associated application; or receiving an association relationship creating instruction issued by a user, where the association relationship creating instruction includes an identifier of any one associated application, and an associated application corresponding to the identifier of the any one associated application is a local application, and storing locally a correspondence relationship between the identifier of the any one application and the identifier of the any one associated application; or receiving, by the electronic product, association relationships transmitted by the network side, and storing locally the received association relationships.

Optionally after the association relationships are created, if the electronic product receives an association relationship transmitted by the network side, then it may compare the received association relationship with the locally stored association relationships, and update one of the locally stored association relationships according to a result of the comparison, where the associated applications corresponding to the identifier of the application to be started are applications invoked by the application to be started.

Optionally the electronic product updates the locally stored association relationships according to the result of the comparison particularly by: for the identifier of an application to be started in each association relationship, comparing the received association relationship with a locally stored corresponding association relationship, and if there is such the identifier of any one application to be started that the received association relationship corresponding to the identifier of the any one application to be started is the same as the locally stored association relationship corresponding to the identifier of the any one application to be started, then maintaining the locally stored association relationship; or if the received association relationship corresponding to the identifier of the any one application to be started is different from the locally stored association relationship corresponding to the identifier of the any one application to be started, then retrieving different one of the received association relationships from the locally stored association relationship, and updating the locally stored association relationship with the retrieved association relationship, where the locally stored association relationship is updated with the retrieved association relationship by replacing the locally stored association relationship with the received association relationship if the locally stored association relationship includes the identifier of the application to be started in the received association relationship, or adding locally the retrieved association relationship directly if the locally stored association relationship does not include the identifier of the application to be started in the received association.

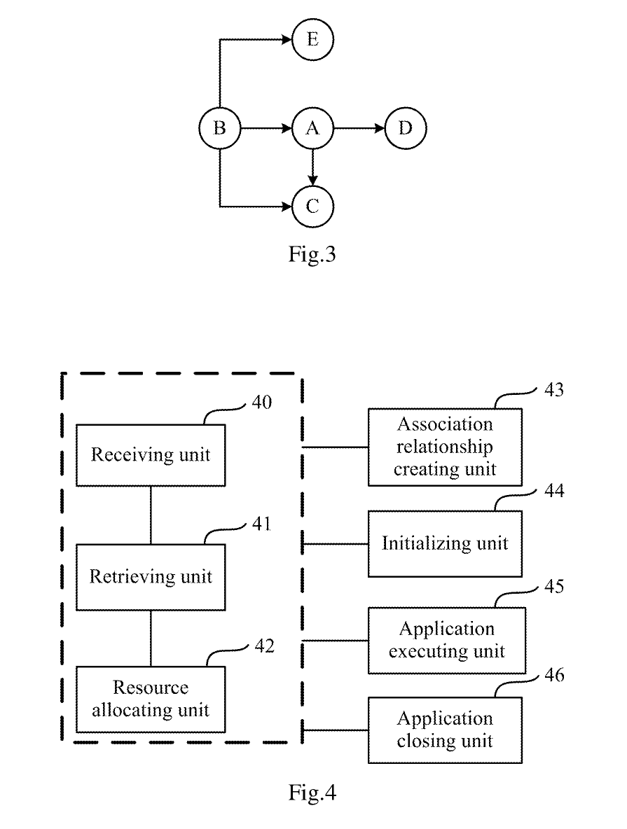

Optionally the association relationships can be presented in the form of a table (see FIG. 2); or the association relationships can be presented in the form of a construct graph (see FIG. 3). The identifier of one application to be started can correspond to identifiers of a plurality of associated applications, where referring to FIG. 2, for example, there are two associated applications, including an application B and an application C respectively, corresponding to an application A; or the identifier of one application to be started can correspond to an identifier of one associated application, where referring to FIG. 2, for example, there is one associated application, including only the application C, corresponding to the application B. In FIG. 3, an application is represented as a circular, and an invoking relationship is represented as an arrow, where in FIG. 3, for example, the associated applications corresponding to the application A are the application C and the application D, and the associated applications corresponding to the application B are an application E, the application A, and the application C.

With the technical solution above, the electronic product parses each of the local applications for the identifier of an application associated with the application, or the user sets different association relationships between the identifiers of the applications for particular application scenarios, and stores the identifiers of the applications associated with each other into a pre-created association relationship table or association relationship construct graph, so that the association relationships can be created conveniently and rapidly while guaranteeing the accuracy of the created association relationships.

The operation 120 is to allocate memory resources to all or a part of the associated applications corresponding to the retrieved identifiers of the associated applications.

In an embodiment of the disclosure, the electronic products starts the application to be started, in response to the application start instruction issued by the user, or the application start instruction issued by another electronic product; and at this time, the electronic allocates corresponding memory resources to all or a part of the retrieved associated applications, that is, buffers all or a part of the associated applications into a memory.

Furthermore if the pre-stored association relationships do not include the identifier of the application to be started, then the electronic product may start only the application to be started, corresponding to the identifier of the application to be started without allocating any memory space for the other application.

With the technical solution above, the electronic product may buffer the associated application corresponding to the application to be started, into the memory while starting the application to be started, so no memory resource need be allocated again to the associated application if the associated application needs to be started, to thereby shorten effectively a period of time for the electronic product to start the associated application.

Furthermore the electronic products detects in real time a received associated application execution instruction which can be generated in a number of forms, for example, if the electronic products detects that the user selects any one functional option, in the application to be started, corresponding to an associated application, then the electronic product may determine the selection operation as the associated application execution instruction issued by the user; or if the user inputs the identifier of an associated application, in the user interaction interface of the electronic product, and decides to execute the associated application corresponding to the identifier of the associated application, then the electronic product may determine the operation of executing the associated application as the associated application execution instruction.

If the electronic product triggers the associated application execution instruction through the application to be started, then the associated application corresponding to the identifier of the any one associated application in the memory may be invoked and executed directly.

In an embodiment of the disclosure, if any one associated application needs to be started, then no memory resource need be allocated again to the any one associated application, instead the any one associated application may be invoked directly from the memory, so the disclosure can shorten a period of time for the electronic product to start the associated application as compared with a process of starting any one associated application corresponding to an application to be started in the prior art.

Furthermore after the electronic product allocates the memory resources respectively to the associated applications corresponding to the respective retrieved identifiers of the associated applications, the electronic products performs for any one of the associated applications the operations of: obtaining a list of functional scripts allowed to be started, in the any one associated application; and initializing each of the functional scripts allowed to be started, in the list of functional scripts allowed to be started, where the functional script is a functional module which can perform a specific function, and which is consisted of codes. For example, for the associated application A, there are a functional script a1 and a functional script a2 in a list thereof of functional scripts allowed to be started, and the electronic product initializes locally the functional script a1 and the functional script a2 after buffering the associated application A into the memory. With the technical solution above, the electronic product initializes functional scripts allowed to be started, of an associated application, and if the associated application needs to be started, then no memory resource need be allocated again to the associated application, and the functional scripts allowed to be started need not be initialized again, thus further shortening the period of time for the electronic product to start the associated application.

Furthermore after the electronic product starts the application to be started, corresponding to the identifier of the application to be started, if the electronic product receives an application close instruction issued by the user, then it obtains the identifier of the application to be started, in the application close instruction; and releases respectively the memory resources allocated to the associated applications corresponding to the identifiers of the respective associated applications while closing the application to be started, corresponding to the identifier of the application to be started, where each of the identifiers of the associated applications identifies an executed associated application corresponding to the application to be started, or an unexecuted associated application corresponding to the application to be started. With the technical solution above, if the application to be started is closed, the memory resources allocated to the respective associated applications corresponding to the application to be started may be released to thereby avoid the problems of wasted memory spaces and a slowed operating speed of the system, due to the memory spaces in which the associated application reside after the application to be started is closed.

Based on the technical solution above, referring to FIG. 4, an embodiment of the disclosure further provides a device for staring an application, which includes a receiving unit 40, a retrieving unit 41 and a resource allocating unit 42, wherein:

The receiving unit 40 is configured to receive an application start instruction including an identifier of an application to be started;

The retrieving unit 41 is configured to retrieve at least an identifier of one associated application corresponding to the identifier of the application to be started, from pre-stored association relationships which are correspondence relationships between identifiers of applications to be started and identifiers of associated applications; and

The resource allocating unit 42 is configured to allocate memory resources to all or a part of the associated applications corresponding to the retrieved identifiers of the associated applications.

Furthermore the device further includes an association relationship creating unit 43 configured to perform for any one of local applications the operations of: parsing the any one application for all the functional scripts in the any one application, obtaining an application corresponding to each of the function scripts respectively, and if there is locally an application corresponding to the function script, then determining the application corresponding to the function script as an associated application corresponding to the any one application, and storing locally an association relationship between the identifier of the any one application and the identifier of the associated application; or receiving an association relationship creating instruction, where the association relationship creating instruction includes an identifier of any one associated application, and an associated application corresponding to the identifier of the any one associated application is a local application, and storing locally an association relationship between the identifier of the any one application and the identifier of the any one associated application; or receiving association relationships transmitted by the network side, and storing locally the received association relationships.

Furthermore the association relationship creating unit 43 is further configured, after the association relationships are stored locally, to receive an association relationship transmitted by the network side; and to compare the received association relationship with the locally stored association relationships, and to update one of the locally stored association relationships according to a result of the comparison.

Furthermore the device further includes an initializing unit 44 configured, after memory resources are allocated to all or a part of the associated applications corresponding to the retrieved identifiers of the associated applications, to perform for any one of the associated applications the operations of: obtaining a list of functional scripts allowed to be started, in the any one associated application; and initializing each of the functional scripts allowed to be started.

Furthermore the receiving unit 40 is further configured to receive an associated application execution instruction including the identifier of any one of the associated applications corresponding to the identifier of the application to be started; and the device further includes an application executing unit 45 configured to invoke and execute the associated application corresponding to the identifier of the any one associated application from a memory.

Optionally the application executing unit 45 is configured to retrieve each of functional scripts in the associated application corresponding to the identifier of the any one associated application; and if there is any initialized one of the retrieved functional scripts, to execute the any one functional script directly, or if there is any non-initialized one of the retrieved functional scripts, to initialize the any one functional script, and to execute the initialized any one functional script.

Furthermore the receiving unit 40 is further configured to receive an application close instruction including the identifier of the application to be started, after receiving the application start instruction; and the device further includes an application closing unit 46 configured to release respectively the memory resources allocated to the associated applications corresponding to the identifiers of the respective associated applications while closing the application to be started, corresponding to the identifier of the application to be started.

In summary, in the embodiments of the disclosure, an application start instruction including the identifier of an application to be started is received; the at least an identifier of one associated application corresponding to the identifier of the application to be started is retrieved from pre-stored association relationships which are correspondence relationships between identifiers of applications to be started and identifiers of associated applications; memory resources are allocated respectively to the associated applications corresponding to the respective retrieved identifiers of the associated applications, or a part of functional scripts allowed to be started are initialized, while the application to be started, corresponding to the identifier of the application to be started is started; an associated application execution instruction including the identifier of any one of the associated applications corresponding to the identifier of the application to be started is received; and the associated application corresponding to the identifier of the any one associated application, in a memory is invoked and executed directly. With the technical solution according to the disclosure, an electronic product creates an association relationship table locally, and stores the identifiers of the respective local applications and the identifiers of their corresponding associated applications into the association relationship table, and if a user needs to start any one application to be started, then the electronic product may retrieve the identifier of the corresponding associated application from the association relationship table, and buffer the associated application corresponding to the retrieved identifier of the associated application into the memory, so that if the user needs to start the associated application, then the electronic product may invoke the associated application directly from the memory without rescheduling to buffer the associated application into the memory, thereby shortening a period of time for executing the application; and the electronic product can further initialize a functional script allowed to be started, after the associated application is buffered into the memory, and if the associated application needs to be started, then the electronic product may execute directly the functional script allowed to be started, without rescheduling to initialize the functional script allowed to be started, thereby further shortening the period of time for executing the application.

An embodiment of the disclosure further provides a device for associating applications, which includes a memory storing codes, and a processor executing the codes to perform:

Receiving an application start instruction including an identifier of an application to be started;

Retrieving at least an identifier of one associated application corresponding to the identifier of the application to be started, from pre-stored association relationships which are correspondence relationships between identifiers of applications to be started and identifiers of associated applications; and

Allocating memory resources to all or a part of the associated applications corresponding to the retrieved identifiers of the associated applications.

Optionally the processor is further configured to execute the codes to perform:

Performing for any one of local applications the operations of: parsing the any one application for all the functional scripts in the any one application, obtaining an application corresponding to each of the function scripts respectively, and if there is locally an application corresponding to the function script, then determining the application corresponding to the function script as an associated application corresponding to the any one application, and storing locally an association relationship between the identifier of the any one application and the identifier of the associated application; or receiving an association relationship creating instruction, where the association relationship creating instruction includes an identifier of any one associated application, and an associated application corresponding to the identifier of the any one associated application is a local application, and storing locally an association relationship between the identifier of the any one application and the identifier of the any one associated application; or receiving association relationships transmitted by the network side, and storing locally the received association relationships.

Optionally the processor is further configured to execute the codes to perform:

After the association relationships are stored locally, receiving an association relationship transmitted by the network side; and comparing the received association relationship with the locally stored association relationships, and updating one of the locally stored association relationships according to a result of the comparison.

Optionally the processor is further configured to execute the codes to perform:

After memory resources are allocated to all or a part of the associated applications corresponding to the retrieved identifiers of the associated applications, performing for any one of the associated applications the operations of: obtaining a list of functional scripts allowed to be started, in the any one associated application; and initializing each of the functional scripts allowed to be started.

Optionally the processor is further configured to execute the codes to perform:

Receiving an associated application execution instruction including the identifier of any one of the associated applications corresponding to the identifier of the application to be started; and

Invoking and executing the associated application corresponding to the identifier of the any one associated application from a memory.

Optionally the processor is further configured to execute the codes to perform:

Receiving an application close instruction including the identifier of the application to be started, after the application to be started, corresponding to the identifier of the application to be started is started; and

Releasing respectively the memory resources allocated to the associated applications corresponding to the identifiers of the respective associated applications while closing the application to be started, corresponding to the identifier of the application to be started.

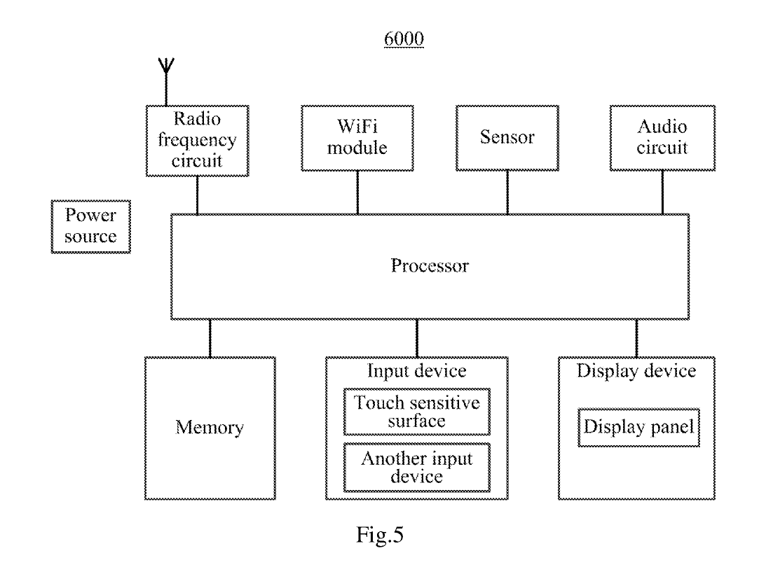

Optionally in the embodiments of the disclosure, the device starting the application can be a server, a terminal, etc. Referring to FIG. 5, the terminal 6000 can be any one of various handheld devices (e.g., a handset, a tablet computer, a PDA, etc.), which can include one or more processors including processing cores, a radio frequency circuit, a memory including one or more computer readable storage mediums, an input device, a display component, a sensor, an audio circuit, a WiFi module, a power source, and other components. Those skilled in the art can appreciate that the structure of the terminal device 6000 in this embodiment will not be intended to be limiting but can include more or fewer components or have some of the components combined or different components arranged, where:

The radio frequency circuit can be configured to receive and transmit a signal in the course of receiving and transmitting information or in communication, particularly by transferring downlink information received from a base station to the one or more processors for processing upon reception of the downlink information; and also transmitting uplink data to the base station. Typically the radio frequency circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the radio frequency circuit can further communicate with a network and another device through wireless communication. The wireless communication can comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

The memory can be configured to store software programs and modules, and the processor is configured to run the software programs and modules stored in the memory to thereby perform various function applications and data processing. The memory can generally include a program storage area and a data storage area, where an operating system, applications required for at least one function (e.g., an audio playing function, an image playing function, etc.), etc., can be stored in the program storage area; and data created for use of the terminal 6000 (e.g., audio data, an address book etc.), etc., can be stored in the data storage area. Moreover the memory can include a high-speed random access memory and can further include a nonvolatile memory, e.g., at least one magnetic-disk memory device, flash memory device, or another volatile solid memory device. Correspondingly the memory can further include a memory controller configured to provide an access to the memory for the processor and the input device.

The input device can be configured to receive input digital or character information and to generate a keyboard, mouse, joystick, optical or track ball signal input related to user setting and function control. Particularly the input device can include a touch sensitive surface and another input device. The touch sensitive surface, also referred to as a touch display screen or a touch control pad, can be configured to collect a touch operation by a user thereon or in proximity thereto (e.g., an operation by the user on or in proximity to the touch sensitive surface using his or her finger, a stylus or any other appropriate object or attachment) and to drive a corresponding connected device by preset program. Optionally the touch sensitive surface can include two components which are a touch detection device and a touch controller, where the touch detection device detects the position of touching by the user and detects a signal as a result of the touch operation and transfers the signal to the touch controller; and the touch controller receives the touch signal from the touch detection device and converts it into coordinates of a touch point and further transfers them to the processor and can receive and execute a command sent by the processor. Moreover the touch sensitive surface can be embodied in various types of resistive, capacitive, infrared, surface sound wave and other types. The input device can further include another input device in addition to the touch sensitive surface. Particularly the other input device can include but will not be limited to one or more of a physical keyboard, functional buttons (e.g., volume control buttons, a power-on or-off button, etc.), a track ball, a mouse, a joystick, etc.

The display device can be configured to display information input by the user or information provided to the user, and various graphic user interfaces of the terminal 6000, where these graphic user interfaces can be composed of graphics, texts, icons, videos and any combination thereof. The display device can include a display panel which can be optionally configured in the form of a Liquid Crystal Display (LCD), an Organic Light-Emitting Diode (OLED) display, etc. Furthermore the touch sensitive surface can overlie the display panel, and the touch sensitive surface, upon detection of the touch operation thereon or in proximity thereto, transfers it to the processor to determine the type of the touch event, and thereafter the processor provides a corresponding visual output on the display panel according to the type of the touch event. Although the touch sensitive surface and the display panel are embodied in this embodiment as two separate components to perform the input and output functions, the touch sensitive surface and the display panel can be integrated to perform the input and output functions in some embodiments.

The terminal 6000 can further include at least one sensor, e.g., an optical sensor, a motion sensor, and other sensors. Particularly the optical sensor can include an ambient optical sensor and a proximity sensor, where the ambient optical sensor can adjust the brightness of the display panel according to the luminosity of ambient light rays, and the proximity sensor can power off the display panel and/or a backlight when the terminal 6000 moves in proximity to an ear. A gravity acceleration sensor which is a motion sensor can detect the magnitudes of accelerations in respective directions (typically three axes), and can detect the magnitude and the direction of gravity when the sensor is stationary and can be configured to perform applications of identifying the posture of a handset (e.g., switching between landscape and portrait modes, relevant games, calibration of the posture of a magnetometer, etc.), a relevant function of identifying vibration (e.g., a pedometer, a knock, etc.), etc.; and the terminal 6000 can be further configured with a gyroscope, a barometer, a hygrometer, a thermometer, an infrared sensor and other sensors, and a repeated description of these components will be omitted here.

The audio circuit, a speaker and a transducer can provide an audio interface between the user and the terminal 6000. The audio circuit can convert received audio data into an electric signal and transmit the electric signal to the speaker, which is converted by the speaker into an audio signal for output; and on the other hand, the transducer converts a collected audio signal into an electric signal which is received by the audio circuit and then converted into audio data, and the audio data is further output to the processor for processing and then transmitted to another apparatus through the radio frequency circuit, for example, or the audio data is output to the memory for further processing. The audio circuit may further include an earphone jack for communication between a peripheral earphone and the terminal 6000.

The WiFi falls into the category of short-range wireless transmission technologies, and the terminal 6000 can assist the user in receiving and transmitting an e-mail, browsing a webpage, accessing streaming media, etc., through the WiFi module by which the user is provided with a wireless access to the broadband Internet. Although the WiFi module is illustrated in this embodiment, it can be appreciated that it may not be necessarily required for the terminal 6000 but can be omitted as desired without departing from the scope of the disclosure.

The processor is a control component of the terminal 6000, has the respective components connected by various interfaces and lines, and runs or executes the software programs and/or modules stored in the memory and invokes the data stored in the memory to perform the various functions of the terminal 6000 and process the data to thereby manage and control the handset as a whole. Optionally the processor can include one or more processing cores; and preferably the processor can be integrated with an application processor and a modem processor, where the application processor generally handles the operating system, the user interfaces, the applications, etc., and the modem processor generally handles wireless communication. As can be appreciated, the modem processor above may not be integrated into the processor.

The terminal 6000 further includes a power source (e.g., a battery) powering the respective components, and preferably the power source can be logically connected with the processor through a power management system to thereby perform charging and discharging management, power consumption management, etc., through the power management system. The power source can further include one or more direct current or alternating current power sources, recharging systems, power source failure detection circuits, power source transformers or inverters, power source status indicators, and any other components.

Although not illustrated, the terminal 6000 can further include a webcam, a Bluetooth module, etc., and a repeated description thereof will be omitted here. In an embodiment, the display device of the terminal 6000 is a touch screen display, and the terminal 6000 further includes a memory in which one or more programs are stored and configured to be executed by the one or more processors.

In the embodiments of the disclosure, the electronic product obtains the identifier of the application to be started, in the application start instruction issued by the user upon reception of the application start instruction; searches the locally stored association relationship table for the identifiers of the respective associated applications corresponding to the identifier of the application to be started; and allocates memory resources for the associated applications corresponding to the found identifiers of the associated applications while starting the application to be started, corresponding to the identifier of the application to be started. With the technical solutions according to the disclosure, the electronic product retrieved the associated applications associated with the application to be started before the application to be started is started, and allocates memory resources for the retrieved associated applications while starting the application to be started, so that the associated applications enter a start ready state, and if the associated applications need to be started, then no memory resources need be allocated again for the associated applications, instead the associated applications in the memory may be executed directly, thereby shortening a period of time for starting the associated applications and improving the performance of the system.

Those skilled in the art shall appreciate that the embodiments of the disclosure can be embodied as a method, a system or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, a CD-ROM, an optical memory, etc.) in which computer useable program codes are contained.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational operations are performed on the computer or the other programmable data processing device to create a computer implemented process so that the instructions executed on the computer or the other programmable device provide operations for performing the functions specified in the flow(s) of the flow chart and/or the block(s) of the block diagram.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A device for associating applications, the device comprising a memory storing codes, and a processor executing the codes to perform:
receiving an application start instruction comprising an identifier of an application to be started;
retrieving at least an identifier of one associated application corresponding to the identifier of the application to be started, from pre-stored association relationships which are correspondence relationships between identifiers of applications to be started and identifiers of associated applications; and
allocating memory resources to all or a part of the associated applications corresponding to the retrieved identifiers of the associated applications.

2. The device according to claim 1, wherein the processor is further configured to execute the codes to perform:
performing for any one of local applications the operations of:
parsing the any one application for all the functional scripts in the any one application;
obtaining an application corresponding to each of the function scripts respectively, and if there is locally an application corresponding to the function script, then determining the application corresponding to the function script as an associated application corresponding to the any one application; and storing locally an association relationship between the identifier of the any one application and the identifier of the associated application; or
receiving an association relationship creating instruction, wherein the association relationship creating instruction comprises an identifier of any one associated application, and an associated application corresponding to the identifier of the any one associated application is a local application; and storing locally an association relationship between the identifier of the any one application and the identifier of the any one associated application; or
receiving association relationships transmitted by the network side, and storing locally the received association relationships.

3. The device according to claim 2, wherein the processor is further configured to execute the codes to perform:
after the association relationships are stored locally, receiving an association relationship transmitted by the network side; and comparing the received association relationship with the locally stored association relationships, and updating one of the locally stored association relationships according to a result of the comparison.

4. The device according to claim 1, wherein the processor is further configured to execute the codes to perform:
after memory resources are allocated to all or a part of the associated applications corresponding to the retrieved identifiers of the associated applications, performing for any one of the associated applications the operations of: obtaining a list of functional scripts allowed to be started, in the any one associated application; and initializing each of the functional scripts allowed to be started.

5. The device according to claim 2, wherein the processor is further configured to execute the codes to perform:
after memory resources are allocated to all or a part of the associated applications corresponding to the retrieved identifiers of the associated applications, performing for any one of the associated applications the operations of: obtaining a list of functional scripts allowed to be started, in the any one associated application; and initializing each of the functional scripts allowed to be started.

6. The device according to claim 3, wherein the processor is further configured to execute the codes to perform:
after memory resources are allocated to all or a part of the associated applications corresponding to the retrieved identifiers of the associated applications, performing for any one of the associated applications the operations of: obtaining a list of functional scripts allowed to be started, in the any one associated application; and initializing each of the functional scripts allowed to be started.

7. The device according to claim 4, wherein the processor is further configured to execute the codes to perform:
receiving an associated application execution instruction comprising the identifier of any one of the associated applications corresponding to the identifier of the application to be started; and
invoking and executing the associated application corresponding to the identifier of the any one associated application from a memory.

8. The device according to claim 5, wherein the processor is further configured to execute the codes to perform:
receiving an associated application execution instruction comprising the identifier of any one of the associated applications corresponding to the identifier of the application to be started; and
invoking and executing the associated application corresponding to the identifier of the any one associated application from a memory.

9. The device according to claim 6, wherein the processor is further configured to execute the codes to perform:
receiving an associated application execution instruction comprising the identifier of any one of the associated applications corresponding to the identifier of the application to be started; and
invoking and executing the associated application corresponding to the identifier of the any one associated application from a memory.

10. The device according to claim 4, wherein the processor is further configured to execute the codes to perform:
receiving an application close instruction comprising the identifier of the application to be started, after the application to be started, corresponding to the identifier of the application to be started is started; and
releasing respectively the memory resources allocated to the associated applications corresponding to the identifiers of the respective associated applications while closing the application to be started, corresponding to the identifier of the application to be started.

11. The device according to claim 5, wherein the processor is further configured to execute the codes to perform:
receiving an application close instruction comprising the identifier of the application to be started, after the application to be started, corresponding to the identifier of the application to be started is started; and
releasing respectively the memory resources allocated to the associated applications corresponding to the identifiers of the respective associated applications while closing the application to be started, corresponding to the identifier of the application to be started.

12. The device according to claim 6, wherein the processor is further configured to execute the codes to perform:
receiving an application close instruction comprising the identifier of the application to be started, after the application to be started, corresponding to the identifier of the application to be started is started; and
releasing respectively the memory resources allocated to the associated applications corresponding to the identifiers of the respective associated applications while closing the application to be started, corresponding to the identifier of the application to be started.

13. A method for associating applications, the method comprising:
receiving an application start instruction comprising an identifier of an application to be started;
retrieving at least an identifier of one associated application corresponding to the identifier of the application to be started, from pre-stored association relationships which are correspondence relationships between identifiers of applications to be started and identifiers of associated applications; and
allocating memory resources to all or a part of the associated applications corresponding to the retrieved identifiers of the associated applications.

14. The method according to claim 13, wherein the pre-stored association relationships are created by:
performing for any one of local applications the operations of:
parsing the any one application for all the functional scripts in the any one application;
obtaining an application corresponding to each of the function scripts respectively, and if there is locally an application corresponding to the function script, then determining the application corresponding to the function script as an associated application corresponding to the any one application; and storing locally an association relationship between the identifier of the any one application and the identifier of the associated application; or
receiving an association relationship creating instruction, wherein the association relationship creating instruction comprises an identifier of any one associated application, and an associated application corresponding to the identifier of the any one associated application is a local application; and storing locally an association relationship between the identifier of the any one application and the identifier of the any one associated application; or
receiving association relationships transmitted by the network side, and storing locally the received association relationships.

15. The method according to claim 14, wherein after the association relationships are stored locally, the method further comprises:
receiving an association relationship transmitted by the network side; and
comparing the received association relationship with the locally stored association relationships, and updating one of the locally stored association relationships according to a result of the comparison.

16. The method according to claim 13, wherein after the memory resources are allocated to all or a part of the associated applications corresponding to the retrieved identifiers of the associated applications, the method further comprises:
performing for any one of the associated applications the operations of:
obtaining a list of functional scripts allowed to be started, in the any one associated application; and
initializing each of the functional scripts allowed to be started.

17. The method according to claim 14, wherein after the memory resources are allocated to all or a part of the associated applications corresponding to the retrieved identifiers of the associated applications, the method further comprises:
performing for any one of the associated applications the operations of:
obtaining a list of functional scripts allowed to be started, in the any one associated application; and
initializing each of the functional scripts allowed to be started.

18. The method according to claim 15, wherein after the memory resources are allocated to all or a part of the associated applications corresponding to the retrieved identifiers of the associated applications, the method further comprises:
performing for any one of the associated applications the operations of:
obtaining a list of functional scripts allowed to be started, in the any one associated application; and
initializing each of the functional scripts allowed to be started.

19. The method according to claim 16, wherein the method further comprises:
retrieving the identifier of any one of the associated applications, in an associated application execution instruction issued by the application be started, which correspond to the identifier of the application to be started, upon reception of the associated application execution instruction; and
invoking and executing the associated application corresponding to the identifier of the any one associated application from a memory.

20. The method according to claim 16, wherein after the application to be started, corresponding to the identifier of the application to be started is started, the method further comprises:
receiving an application close instruction comprising the identifier of the application to be started; and
releasing respectively the memory resources allocated to the associated applications corresponding to the identifiers of the respective associated applications while closing the application to be started, corresponding to the identifier of the application to be started.
